(19) United States
(12) Patent Application Publication
(10) Pub. No.: US 2014/0341661 A1
(43) Pub. Date: Nov. 20, 2014

(54) MILLING CUTTER

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: GANG LIN, Shenzhen (CN); JIAN-FENG PI, Shenzhen (CN); LIN-HE ZOU, Shenzhen (CN); HAI-SONG HU, Shenzhen (CN); QIONG-GANG CHENG, Shenzhen (CN); YAN-JIE AN, Shenzhen (CN); XING XING, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/280,669

(22) Filed: May 19, 2014

(30) Foreign Application Priority Data
May 20, 2013 (CN) 2013101863761

(51) Int. Cl. B23C 5/12; B23C 5/10

(52) U.S. Cl. CPC B23C 5/12; B23C 5/10; B23C 2210/40
USPC 407/53

(57) ABSTRACT

A milling cutter employed to mill top and bottom edges of a workpiece comprises a handle and a cutting head formed on an end of the handle. The cutting head comprises a first processing end coupled to the handle and a second processing end formed on an end of the first processing end away from the handle. The first processing end comprises a first cutting portion extending along a clockwise direction for chamfering the top edge of the workpiece, and the second processing end comprises a second cutting portion extending along a counterclockwise direction for chamfering the bottom edge of the workpiece.

### FIELD

The present disclosure relates to a cutter, and more particularly, to a milling cutter capable of chamfering top and bottom edges of a workpiece simultaneously.

### BACKGROUND

In machining processing, periphery edges of workpiece are chamfered to form an annular surface. A first milling cutter is used for chamfering a top edge of the workpiece to form an annular surface, and a second milling cutter is used for chamfering a bottom edge of the workpiece to form an annular surface. After the top edge is chamfered, the first milling cutter is removed, and the second milling cutter is positioned adjacent to the bottom edge of the workpiece. After the bottom edge is chamfered, the second milling cutter is removed, and the first milling cutter is positioned adjacent to the top edge of the workpiece.

### BRIEF DESCRIPTION OF THE DRAWING

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows an isometric view of an embodiment of a milling cuter, the milling cutter includes a first milling end and a second milling end.

FIG. 2 is similar to FIG. 1 but viewed from another aspect.

FIG. 3 shows a top plan view of the second milling end of the milling cutter of FIG. 1.

### DETAILED DESCRIPTION

The term “coupled” is defined as connected whether directly or indirectly through intervening components, and is not necessarily limited to physical connections. The connection can be such that the objects are permanently connected or releasably connected.

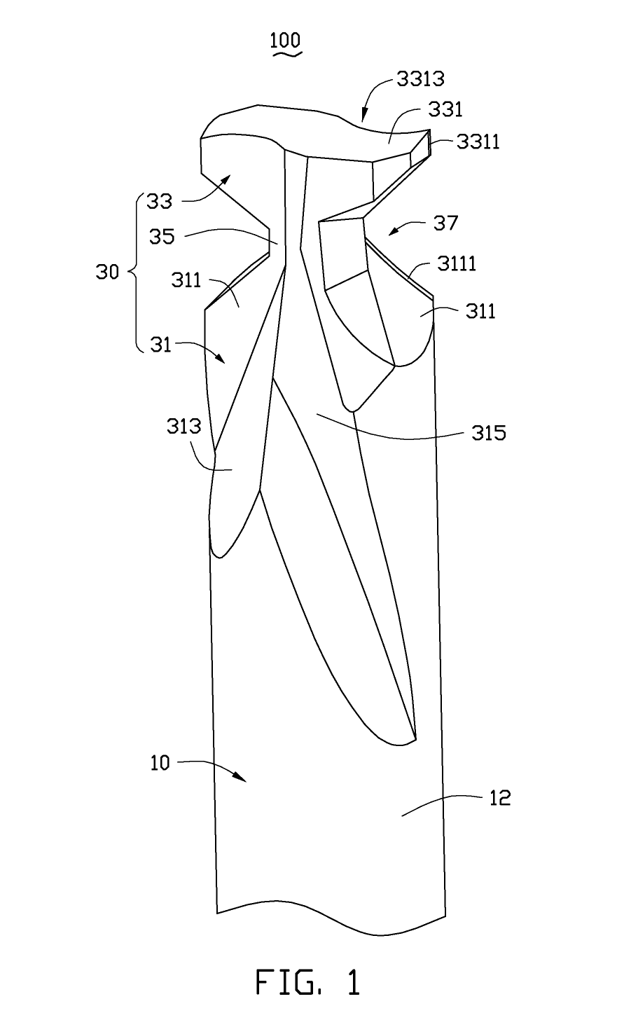

FIG. 1 illustrates an embodiment of a milling cutter 100 including a handle 10 (partially shown in FIG. 1) and a cutting head 30 formed on an end of the handle 10. In the illustrated embodiment, the milling cutter 100 is employed for milling a workpiece (not shown) to form a chamfering surface on both top and bottom edges of a workpiece simultaneously.

The handle 10 can be cylindrical with a rotation axis A. The milling cutter 100 can rotate around the rotation axis A when milling. The handle 10 includes a first end coupled to the cutting head 30, and a second end 12 which can be coupled to a main arbor of a processing machine (not shown) to enable the processing machine to rotate the milling cutter 100, thereby chamfering the workpiece. In the illustrated embodiment, the handle 10 is straight and cylindrical. In other embodiments, the handle 10 can be cone-shaped.

The cutting head 30 can extend from the first end and can include a first processing end 31, a second processing end 33, and a connecting portion 35 interconnecting the first processing end 31 and the second processing end 33. The cutting head 30 can extend along the rotation axis A and can be collinear with the handle 10. A length or thickness of the second processing end 33 along the rotation axis A can be less than that of the first processing end 31. A longest diameter of the second processing end 33 can be greater than the diameter of the connecting portion 35, and a longest diameter of the first processing end 31 can also be greater than the diameter of the connecting portion 35. The first processing end 31, the second processing end 33, and the connecting portion 35 cooperatively form a receiving groove 37 configured for partially receiving the workpiece. The first processing end 31 can be configured for chamfering a top edge of the workpiece to form a top annular surface, and the second processing end 33 can be configured for chamfering a bottom edge of the workpiece to form a bottom annular surface.

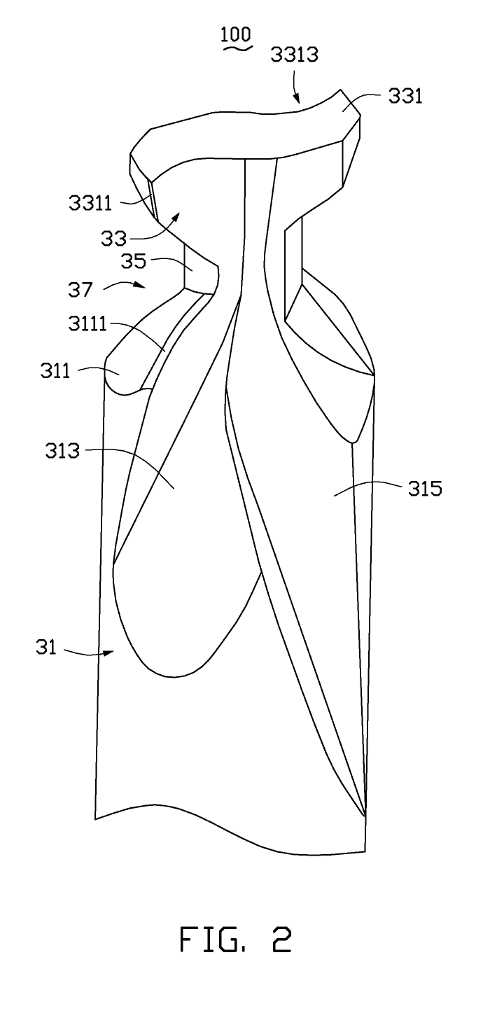

FIG. 2 illustrates that the first processing end 31 can be axisymmetric along the rotation axis A. In the illustrated embodiment, a position of the first processing end 31 after rotating 180 degrees around the rotation axis A can coincide with an initial position thereof. The first processing end 31 can include two first cutting portions 311, two chip guide grooves 313, and two first chip removal grooves 315. The two cutting portions 311, the two chip guide grooves 313, and the two first chip removal grooves 315 can be respectively axisymmetric along the rotation A. The first cutting portion 311, the chip guide groove 313 and the first chip removal groove 315 can be arranged in that order.

The two first cutting portions 311 can be arranged on opposite sides of the rotation axis A, and can be adjacent to the connecting portion 35. The two first cutting portions 311 can extend along a clockwise direction. The first cutting portion 311 can include a first cutting edge 311 configured for chamfering a top edge of the workpiece. The two chip guide grooves 313 can be located on side surfaces of the two first cutting portions 311 adjacent to the first cutting edge 3111. The chip guide groove 313 can extend from an end of the first processing end 31 adjacent to the connecting portion 35 to another end of the first processing end 31 away from the connecting portion 35, and a width of the chip guide groove 313 can gradually decrease along the extending direction. The chip guide groove 313 can be used to drain the cutting chips while the first cutting portion 311 chamfers the workpiece. One part of the cutting chips can be drained to an outer environment through the chip guide groove 313, and another part of the cutting chips can be drained to the first chip removal groove 315 through the chip guide groove 313. In the illustrated embodiment, the bottom surface of the chip guide groove 313 can be an inclined flat surface, and the gradient of the incline plane can be designed in order for the cutting chips to drain quickly to avoid burrs from forming on the surface of the workpiece or decreasing smoothness. Each removal groove 315 is arranged on a side surface of the corresponding chip guide groove 313 away from the corresponding first cutting edge 311. The removal groove 315 is connected to the first cutting portion 311, and extends from the first cutting portion 311 along a direction away from the first cutting portion 311. The first chip removal groove 315 communicates with the chip guide groove 313, therefore the cutting chips can be drained through the first chip guide groove 313 and the first chip removal groove 315 in that order. The cross-sectional view of the first chip removal groove 315 taken perpendicular to the rotation axis A is V-shaped.

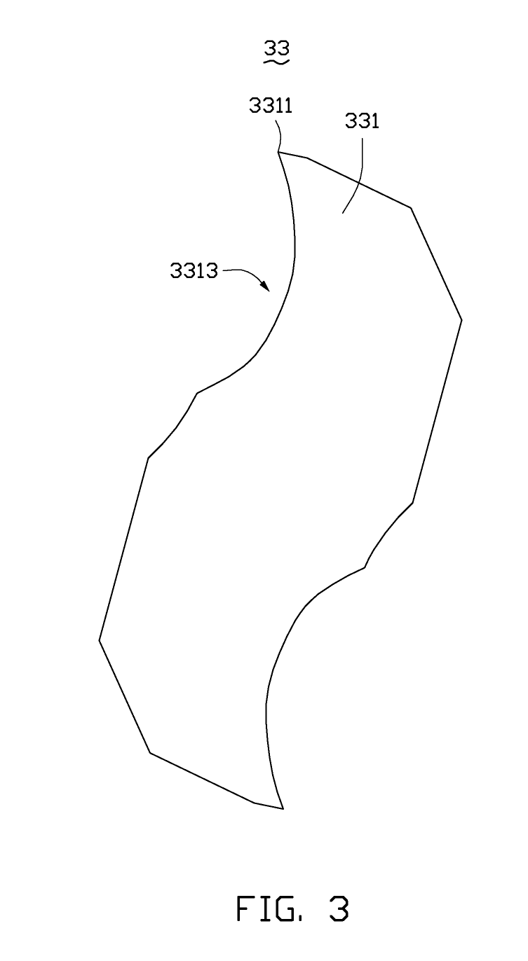

FIG. 3 illustrates that the connecting portion 35 can be coupled to an end away from the handle 10 of the two first cutting portions 311, the two chip guide grooves 313, and the two first chip removal grooves 315. The second processing end 33 can be located on an end of the connecting portion 35 away from the first processing end 31, and an end away from the connecting portion 35 can be planar. The second processing end 33 can include two second cutting portions 331 arranged symmetrically relative to the rotation axis A. The second cutting portion 331 can extend along a counterclockwise direction, thus cutting chips which are formed by the first cutting portion 311 and the second cutting portion 331 can be discharged along different directions. The second cutting portion 331 can include a second cutting edge 3311 configured for chamfering a bottom edge of the workpiece. Each of the second cutting portions 331 can define a second chip removal groove 3313 on a side surface adjacent to the second cutting edge 3311. The second chip removal groove 313 can be curved, and can be configured for draining the cutting chips when the second cutting edge 3311 chamfers the workpiece.

During processing, the handle 10 is held by the main arbor of the numerical control machine. The milling cutter 100 is moved to the workpiece, and the first processing end 31, and the second processing end 33 are positioned on areas to be machined. The workpiece is partially received in the receiving groove 313. When the first cutting portion 311 chamfers the top edge of the workpiece, the cutting chips are discharged to the chip guide groove 313 along a direction towards the handle 10, and the chips are further discharged to the first chip removal groove 315 through the chip guide groove 313. When the second cutting portion 331 chamfers the bottom edge of the workpiece, the cutting chips are discharged to the second chip removal groove 313 along a direction away from the handle 10.

In the illustrated embodiment, the milling cutter 100 chamfers the top and the bottom edges of the workpiece to form annular surfaces simultaneously through the first cutting portion 311 and the second cutting portion 331 respectively. The milling cutter 100 includes the first cutting portion 311 extending along a clockwise direction and the second cutting portion 331 extending along a counterclockwise direction. In this way the cutting chips that are formed by the first cutting portion 331 and the second cutting portion 331 can be discharged to the corresponding chip removal groove in different directions, thus eliminating the formation of burrs on the surface to obtain maximum smoothness. The chip guide groove 313 and the first chip removal groove 315 communicating with the chip guide groove 313, allows the cutting chips formed by the first cutting edge 3111 to be discharged quickly.

The number of the first cutting portions 311 and the second cutting portions 331 can be one or more. Either the chip guide groove 313 or the first chip removal groove 315 can be omitted, and the first chip removal groove 315 can be located adjacent to the first cutting portion 311 when the chip guide groove 313 is omitted. The milling cutter 100 can be used in other machines, as long as the first cutting portion 311 can be arranged along the clockwise direction and the second cutting portion 331 can be arranged along the counterclockwise direction, and the cutting chips which are formed by the first cutting portion 311 and the second cutting portion 331 can be discharged along different directions respectively. The connecting portion 35 can be omitted, and the first processing end 31 can be connected to the second processing end 33 directly.

While the present disclosure has been described with reference to particular embodiments, the description is illustrative of the disclosure and is not to be construed as limiting the disclosure. Therefore, those of ordinary skill in the art can make various modifications to the embodiments without departing from the true spirit and scope of the disclosure, as defined by the appended claims.

What is claimed is:

1. A milling cutter employed to mill top and bottom edges of a workpiece, the milling cutter comprising a handle and a cutting head formed on an end of the handle, wherein the cutting head comprises a first processing end and a second processing end, the first processing end and the second processing end are arranged along a rotation axis of the handle and spaced apart from each other, the first processing end comprises a first cutting portion for chamfering the top edge of the workpiece, and the second processing end comprises a second cutting portion for chamfering the bottom edge of the workpiece.

2. The milling cutter of claim 1, wherein the first processing end comprises a first cutting edge and defines a chip guide groove on a side surface of the first cutting portion adjacent to the first cutting edge.

3. The milling cutter of claim 2, wherein a width of a bottom surface of the chip guide groove gradually increases along a direction from an end of the first processing end adjacent to the second processing end to another end of the first processing end away from the second processing end.

4. The milling cutter of claim 3, wherein the bottom surface of the chip guide groove is an inclined flat surface.

5. The milling cutter of claim 2, wherein the first processing end further defines a first chip removal groove on a side surface of the chip guide groove away from the first cutting portion, and the chip removal groove communicates with the chip guide groove.

6. The milling cutter of claim 5, wherein a cross-sectional view of the first chip removal groove is V-shaped.

7. The milling cutter of claim 1, wherein the second cutting portion comprises a second cutting edge and defines a second chip removal groove on an side surface of the second cutting portion adjacent to the second cutting edge.

8. The milling cutter of claim 1, wherein a length of the second processing end along the rotation axis is less than that of the first processing end.

9. The milling cutter of claim 1, wherein a rotation axis of the first processing end is substantially collinear with a rotation axis of the second processing end.

10. A milling cutter employed to mill top and bottom edges of a workpiece, the milling cutter comprising a handle and a cutting head formed on an end of the handle, wherein the cutting head comprises a first processing end coupled to the handle, and a second processing end formed on an end of the first processing end away from the handle, the first processing end comprises a first cutting portion extending along a clockwise direction for chamfering the top edge of the workpiece, and the second processing end comprises a second cutting portion extending along a counterclockwise direction for chamfering the bottom edge of the workpiece.

11. The milling cutter of claim 10, wherein the first processing end further comprises a first cutting edge and defines a chip guide groove on a side surface of the first cutting portion adjacent to the first cutting edge.

12. The milling cutter of claim 11, wherein a width of a bottom surface of the chip guide groove gradually increases along a direction from an end of the first processing end adjacent to the second processing end to another end of the first processing end away from the second processing end.

13. The milling cutter of claim 12, wherein the bottom surface of the chip guide groove is an inclined flat surface.

14. The milling cutter of claim 11, wherein the first processing end further defines a first chip removal groove located on a side surface of the chip guide groove away from the first cutting portion, and the chip removal groove communicates with the chip guide groove.

15. The milling cutter of claim 14, wherein a cross-sectional view of the first chip removal groove is V-shaped.

16. The milling cutter of claim 10, wherein the second cutting portion comprises a second cutting edge and defines a second chip removal groove on an side surface of the second cutting portion adjacent to the second cutting edge.

17. The milling cutter of claim 10, wherein the cutting head further comprises a connecting portion connecting the first processing end to the second processing end.

18. The milling cutter of claim 17, wherein the first processing end, the second processing end, and the connecting portion cooperatively form a receiving groove configured for partially receiving the workpiece.
